(19) United States
(12) Patent Application Publication
(10) Pub. No.: US 2024/0395170 A1
(43) Pub. Date: Nov. 28, 2024

(54) SURGICAL TRAINING DEVICES AND METHODS

(71) Applicant: Arizona Board of Regents on Behalf of the University of Arizona, Tucson, AZ (US)

(72) Inventor: Diego Celdran-Bonafonte, Tucson, AZ (US)

(21) Appl. No.: 18/674,202

(22) Filed: May 24, 2024

Related U.S. Application Data
(60) Provisional application No. 63/468,903, filed on May 25, 2023.

(51) Int. Cl. G09B 23/34

(52) U.S. Cl. CPC G09B 23/34

(57) ABSTRACT

Surgical training devices, kits, and associated methods are disclosed. The surgical training devices include a body shaped to correspond to an animal. The surgical training devices also include an insert for removable insertion into an opening in the body. The insert can be to be covered by a cover, which can be removably attached to the insert. An entirety or majority of the body, the insert, and the cover can be formed of materials sourced from sources other than the animal.

### CROSS REFERENCE TO RELATED APPLICATIONS

This application claims priority to U.S. provisional patent application No. 63/468,903, titled SURGICAL TRAINING DEVICES AND METHODS, filed on May 25, 2023, the entirety of which is hereby incorporated by reference herein.

### TECHNICAL FIELD

This disclosure is generally directed to the field of surgical training devices and methods, and more particularly to surgical training devices and methods that do not require real animals.

### BACKGROUND

Laboratory animals, particularly rodents, have historically played a crucial role in the training of surgeons and researchers. These animals, due to their physiological similarities to humans, have been used to teach surgical skills, from basic incisions to complex procedures like laparoscopy. The use of live animals has historically provided trainee surgeons and researchers with a dynamic environment to practice and hone their skills, offering a level of tissue realism that has been difficult to replicate.

### SUMMARY

To address shifts in demand and ethical concerns, the inventor recognized the need for surgical training systems and methods that do not rely on living or dead animal subjects, that realistically represent the animal subjects, who are easy to use, and that are affordable. These needs are met by the surgical training devices, kits, and/or training methods according to aspects of this invention. One general aspect includes a surgical training device with a body shaped to correspond to an animal. The surgical training device also includes an insert configured to be removably inserted into an opening in the body. The insert is configured to be covered by a cover that is configured to be removably attached to the insert. An entirety or majority of the body, the insert, and the cover may include materials sourced from sources other than the animal.

Implementations may include one or more of the following features. No portion of the body, the cover, and the insert may include materials sourced from the animal. The surgical training device may include a bodily structure within the insert and an entirety or majority of the bodily structure may include materials sourced from sources other than the animal. The bodily structure is an anatomically accurate reproduction of an organ of the animal and no portion of the bodily structure includes materials sourced from the animal. The bodily structure may include an anatomically accurate reproduction of one or more of a liver, a pancreas, skin, an ovary, a heart, a testicle, a thymus, muscles, a trachea, or a bone of the animal. The animal is a mammal. The animal is a rodent. The animal may include one of a rat, a mouse, a guinea pig, a hamster, a rabbit, a cat, a dog, a bobcat, a javelina, a possum, a raccoon. The opening is defined in a belly of the body. The opening is defined in a back of the body. The insert is a first insert and the surgical training device further may include a second insert. The first insert and the second insert are configured to be interchangeably inserted into the opening in the body. The opening in the body is a first opening and the body further may include a second opening. The second insert is configured to be removably inserted into the second opening in the body. The cover may include a first layer and a second layer. The first layer is an inner layer configured to correspond to internal tissue of the animal and the second layer is an outer layer configured to correspond to skin of the animal. The insert may include an inner frame, an outer frame, and intermediate frame. The inner frame is configured to nest within the intermediate frame and to hold the inner layer in a friction fit between the inner frame and the intermediate frame to tension the inner layer across an opening of the inner frame. The intermediate frame is configured to nest within the outer frame and to hold the outer layer in a friction fit between the intermediate frame and the outer frame to tension the outer layer across an opening of the intermediate frame.

Another general aspect includes a training method using a surgical training device. The training method includes covering a first frame with a first layer. The method also includes forming an insert of the surgical training device by nesting the first frame within a second frame to hold the first layer in a friction fit between the first frame and the second frame to tension the first layer across an opening of the first frame. The method also includes inserting the insert into an opening of a body of the surgical training device. The body is shaped to correspond to an animal. An entirety or majority of the body and the insert may include materials sourced from sources other than the animal. The method also includes performing a surgical training procedure on the first layer.

Implementations may include one or more of the following features. The training method may include trimming, before inserting the insert into the opening, the first layer. Forming the insert may include: covering, after nesting the first frame within the second frame, the second frame with a second layer; and nesting the second frame within a third frame to hold the second layer in a friction fit between the second frame and the third frame to tension the second layer across an opening of the second frame. The training method may include trimming, before inserting the insert into the opening, the first layer and the second layer.

Various additional features and advantages of this invention will become apparent to those of ordinary skill in the art upon review of the following detailed description of the illustrative embodiments taken in conjunction with the accompanying drawings.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 shows a schematic view of a first embodiment of a surgical training device;

FIG. 2 shows a schematic view a first embodiment of a surgical training device kit;

FIG. 3 shows a schematic view of a second embodiment of a surgical training device;

FIG. 4 shows a schematic view of a second embodiment of a surgical training device kit;

FIG. 5 shows an inner frame, an intermediate frame, and a first layer of the surgical training device;

FIG. 6 shows the inner frame nested within the intermediate frame with the first layer tensioned between;

FIG. 7 shows an outer frame and a second layer of the surgical training device;

FIG. 8 shows the intermediate frame nested within the outer frame with the second layer tensioned between;

FIG. 9 shows an inner view of the insert and cover in an assembled configuration;

FIG. 10 shows an outer view of the insert and cover in the assembled configuration prior to insertion into an opening of a body of the surgical training device;

FIG. 11 shows the surgical training device in an assembled configuration;

FIG. 12 shows aspects of a surgical procedure performed on a third embodiment of the surgical training device.

FIG. 13 shows a fourth embodiment of the surgical training device;

FIG. 14 shows a fifth embodiment of the surgical training device;

FIG. 15 shows a sixth embodiment of the surgical training device;

FIG. 16 shows a seventh embodiment of the surgical training device;

FIG. 17 shows an eighth embodiment of the surgical training device; and

FIG. 18 shows a ninth embodiment of the surgical training device.

### DETAILED DESCRIPTION

Aspects of this invention are directed to surgical training devices and kits that include realistic and anatomically accurate animal simulators. The surgical training devices can include any number of anatomical structures that realistically and accurately simulate any number of different animals. For example, the surgical training devices can correspond to a mammal such as a rat, a mouse, a guinea pig, a hamster, a rabbit, a cat, a dog, a bobcat, a javelina, a possum, a raccoon, among other possibilities. The surgical training devices can, in embodiments, correspond to other types of animals and are not limited to mammals. The surgical training devices and kits can include a body structured and arranged to correspond to an animal, and one or more insert that can be removably inserted into a respective one or more opening in the body. The insert can have one or more layers that can represent skin layers and/or muscle layers. The layers can cover the insert. In this context, the terms “layer” and “cover” can be used interchangeably throughout this disclosure. The insert can include, underneath the one or more layers, a bodily structure structured and arranged to correspond to an organ or organ system of the simulated animal. The organ or organ system can include for example, liver, pancreas, skin, ovary, heart, testicles, thymus, muscle, trachea, among other possibilities. In embodiments, the inserts can be single use and/or disposable, while the body can be reusable.

An entirety or majority of the body, the insert, the cover, and the bodily structure can be made of materials sourced from sources other than living or dead animals. The term “sourced from the animal” as used herein, can include sourced from any animal of the genus or species that the surgical training device corresponds to. Accordingly, the surgical training devices and kits can, in embodiments, be formed entirely of materials that do not require harvesting from the living or dead animals that the surgical training devices simulate. For example, in embodiments the surgical training devices and kits can be formed from three-dimensional (3D) printing, though other techniques for manufacturing the surgical training devices and kits are possible. This can advantageously reduce the number of animals used in training and research settings.

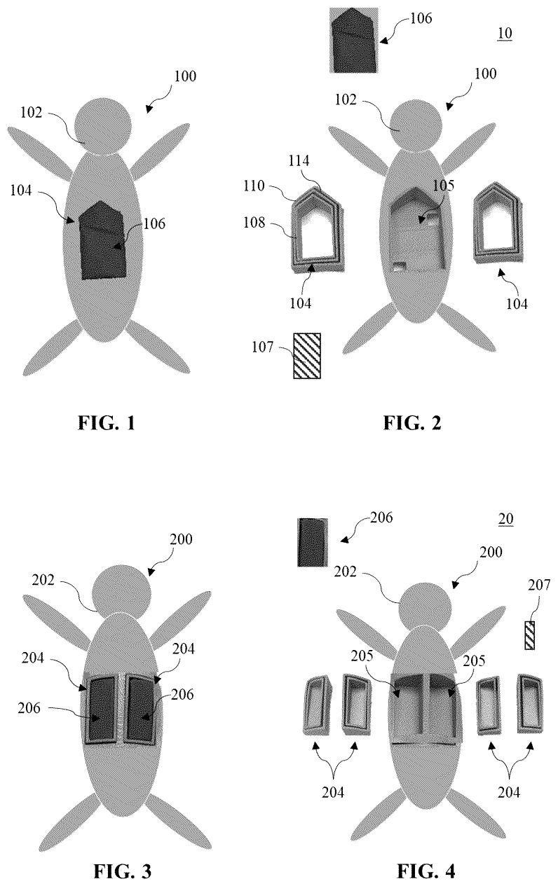

The surgical training devices and kits can be affordably and easily manufactured thereby improving the rate of adoption of the surgical training devices and kits. The surgical training devices and kits can provide a platform for surgeons to practice their surgical skills and techniques prior to performing the surgical techniques on real animals. The surgical training devices and kits can be reusable, which can provide opportunities for surgeons to practice many times and develop confidence and high technical proficiency. This can yield better technical performance and outcomes when performing the procedures on real animals, leading to better experimental results, lower incidence of surgical complications and mortality, and faster and smother post operative recovery. The surgical training devices and kits can thus facilitate improved animal welfare without compromising surgical training efficacy or research. These and other aspects of the invention are described further as follows and are shown in FIGS. 1-18.

FIG. 1 shows a schematic view of a surgical training device 100 according to aspects of the invention. FIG. 2 shows a kit 10 that includes the surgical training device 100. FIG. 3 shows a schematic view of another surgical training device 200 according to aspects of the invention. FIG. 4 shows a kit 20 that includes the surgical training device 200.

The surgical training device 100, and the kit 10, can include a body 102 (shown schematically in FIG. 1) that is structured and arranged to correspond to a particular type of animal. The term “correspond to” when used in reference to an animal can include having the same size, shape, proportion, colors, textures, look, feel, etc. of the animal (or part of the animal) that the surgical training device 100 is intended to simulate, which may be referred herein as the “simulated animal.” In embodiments, the term “correspond to” in this context can mean that the structure has been manufactured to approximate the size, shape, proportion, colors, textures, look, feel, etc. of an actual living or dead, adult or child animal, within manufacturing tolerances that would be understood by those of skill in the art. The simulated animal can be a mammal, such as a rodent, though other types of non-mammalian animals are possible. For example, the simulated animal can be a rat, a mouse, a guinea pig, a hamster, a rabbit, a cat, a dog, a bobcat, a javelina, a possum, a raccoon, among other possibilities.

The surgical training device 100, and the kit 10, can include an insert 104 that can be placed into an opening 105 of the body 102. Any number of openings 105 can be defined in any number of regions of the body 102 for different surgical procedures and the surgical training device 100, and the kit 10, can include an insert 104 for each opening 105. For example, and in embodiments such as shown in FIGS. 1 and 2, a single opening 105 can be formed in a front, torso region of the body 102 and a single insert 104 can be provided within the opening 105 at any given time. In embodiments such as shown in FIGS. 3 and 4, two openings 205 can be formed in a dorsal region of the body 202 and one insert 204 can be provided within each opening 205 at any given time. Other numbers of openings 105 and inserts 104, and other opening locations are possible. As shown in FIGS. 3 and 4, the kit 20 can include more than one insert 104 for each opening 105. For example, after completion of a surgical procedure the inserts 104 can be quickly interchanged while the body 102 can be reused. That can allow another surgical training procedure to occur with a second, fresh insert 104. The used inserts 104 can be discarded, or refurbished (e.g., with a new cover 106 and/or bodily structure 107 described as follows) for further use.

The insert 104 can be removably covered with a cover 106. The cover 106 can be made of any number of materials including for example rubber, latex, nitrile, combinations thereof, among other possibilities. The cover 106 can include one layer or multiple layers (e.g., 2, 3, 4, or more layers). The cover 106 can be an anatomically accurate reproduction of one or more skin (or other tissue) layers of the simulated animal. The kits 10, 20 can include the cover 106. Alternatively, the kits 10, 20 can be provided without the cover 106. In some such embodiments, the cover 106 can be re-purposed from another article (e.g., a laboratory glove), which can improve accessibility of the surgical training device 100 and lower costs associated with the surgical training device 100.

In embodiments, the insert 104 can house a bodily structure 107 (shown schematically in FIGS. 2, 4, and 9). The bodily structure 107 can be structured and arranged as an anatomically accurate reproduction of the organ or other internal structure of the simulated animal. The bodily structure 107 can correspond to the underlying organ or other internal of the simulated animal in structure, in appearance, consistency, color, texture, among other possibilities. For example, the bodily structure 107 can be an anatomically accurate reproduction of one or more of liver, pancreas, skin, ovary, heart, testicles, thymus, muscles, trachea, bone, among other possibilities, of the simulated animal. The bodily structure 107 can allow surgeons to practice advanced surgical procedures. In embodiments, the kits 10, 20 can include the bodily structure 107. Alternatively, the kits 10, 20 can be provided without the bodily structure 107. In some such embodiments, the bodily structure 107 can be re-purposed from another article, which can improve accessibility of the surgical training device 100 and lower costs associated with the surgical training device 100.

The entirety, or substantial majority, of the surgical training device 100 including the entirety or substantial majority of the body 102, the insert 104, the cover 106, and the bodily structure 107 can be formed of materials sourced from sources other than the animal. In embodiments, no portion of the surgical training device 100 including the body 102, the insert 104, the cover 106, and the bodily structure 107 are formed of materials sourced from the simulated animal. This has the benefit of reducing the number of animals needed for surgical training while still allowing surgeons to be trained on a surgical training device 100 that realistically represents the animal. In embodiments, the surgical training device 100 including any or each of the body 102, the insert 104, the cover 106, and the bodily structure 107, can be manufactured using 3D printing, molding, casting, combinations thereof, among other possibilities. In embodiments, the surgical training device 100 including any or each of the body 102, the insert 104, the cover 106, and the bodily structure 107, can be manufactured from a wide range of materials, including but not limited to thermoplastics like acrylonitrile butadiene styrene (ABS) and polylactic acid (PLA), resin, metal powders for sintering, nylon, polycarbonate, and flexible materials such as thermoplastic polyurethane (TPU) and thermoplastic elastomers (TPE). The materials can be selected for creating bodily structures 107 with varying degrees of strength, flexibility, and functionality and to best correspond to the analogous bodily structure(s) of the simulated animal. The kits 10, 20 can include the bodily structure 107.

Except where expressly indicated to the contrary or where clearly mutually exclusive, the surgical training device 200 can include each of the structures, features, and relationships previously described with respect to the surgical training device 100 and vice versa. This can include for example the body 202 with openings 205, inserts 204, covers 206, bodily structures 207, etc.

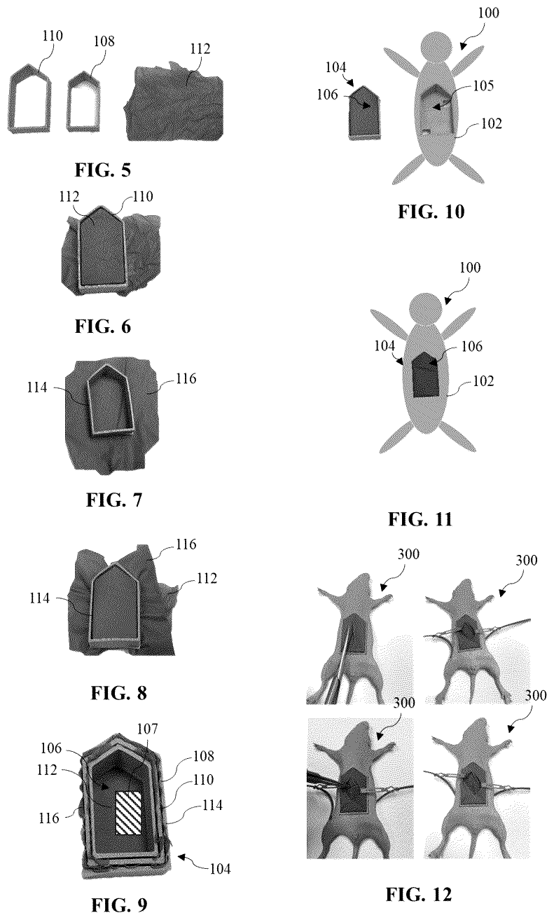

The insert 104 can be covered with the cover 106 using any number of configurations and techniques to simulate anatomy of the animal the surgical training device 100 represents. For example, in embodiments the insert 104 can be formed of any number of frames that can hold any number of covers 106 to simulate skin or other tissue that a surgeon may operate on. As shown in FIG. 5, the insert 104 can include a first frame 108 (i.e., an inner frame) and a second frame 110 (i.e., an outer or an intermediate frame) and the cover 106 can include a first layer 112. As shown in FIG. 6, the first layer 112 can be placed over an opening of the first frame 108 such that the opening of the first frame 108 can be completely covered by the first layer 112 with material of the first layer 112 draping over sides of the first frame 108. The first frame 108 can nest within the second frame 110 with material of the first layer 112 held in a friction fit between sides of the first frame 108 and the second frame 110. This friction fit can tension the first layer 112 across the opening of the inner frame 108 to simulate anatomy of the animal, such as an inner layer of skin. Excess first layer 112 can be trimmed.

In embodiments such as shown in FIG. 7, the insert 104 can include a third frame 114 (i.e., an outer frame) and the cover can include a second layer 116. As shown in FIG. 8, the second layer 116 can be placed over an opening of the second frame 110 such that the opening of the second frame 110 can be completely covered by the second layer 116 with material of the second layer 116 draping over sides of the second frame 110. The second frame 110 can nest within the third frame 114 with material of the second layer 116 held in a friction fit between sides of the second frame 110 and the third frame. This friction fit can tension the second layer 116 across the opening of the second frame 110 to simulate anatomy of the animal, such as an outer layer of skin. Excess second layer 116 can be trimmed.

FIG. 9 shows an inner view of an embodiment of the insert 104 and the cover 106 in an assembled configuration. The interior of the insert 104 can contain the bodily structure 107, as described previously. FIG. 10 shows an outer view of the insert 104 and the cover 106 in the assembled configuration prior to insertion into the opening 105 of the body 102. FIG. 11 shows a surgical training device 100 in assembled configuration with the insert 104 assembled to the cover 106 and inserted into the opening 105 of the body 102.

FIG. 12 shows views of various surgical procedures being performed on a third embodiment of the surgical training device 300, which corresponds to a rodent. Example surgical techniques that can be practiced using any of the surgical training devices described herein can include incising, suturing, clamping, among other surgical techniques. Except where expressly indicated to the contrary or where clearly mutually exclusive, the surgical training device 300 can include each of the structures, features, and relationships previously described with respect to the surgical training devices 100, 200 and vice versa. This can include for example the body with openings, inserts, covers, bodily structures, etc.

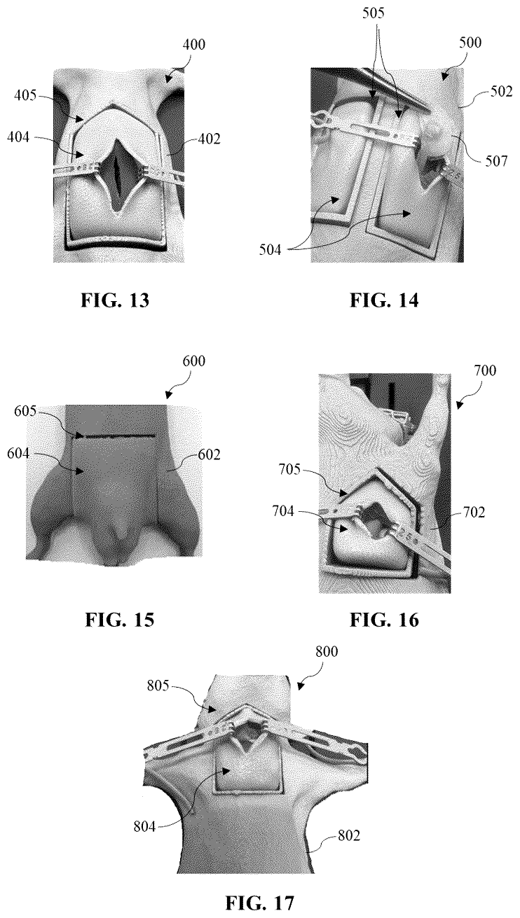

FIG. 13 shows a fourth embodiment of the surgical training device 400. Except where expressly indicated to the contrary or where clearly mutually exclusive, the surgical training device 400 can include each of the structures, features, and relationships previously described with respect to the surgical training devices 100, 200, 300 and vice versa. This can include for example the body 402 with the opening 405, the insert 404, covers, bodily structures, etc. The body 402, the opening 405, and the insert 404 can be structured and arranged for simulating a laparotomy procedure. For example, the opening 405 can be formed in a torso region of the body 402 and the insert 404 can include bodily structures corresponding to an abdomen of the simulated animal.

FIG. 14 shows a fifth embodiment of the surgical training device 500. Except where expressly indicated to the contrary or where clearly mutually exclusive, the surgical training device 500 can include each of the structures, features, and relationships previously described with respect to the surgical training devices 100, 200, 300, 400 and vice versa. This can include for example the body 502 with two openings 505, two inserts 504 each associated with a respective opening 505, covers, bodily structures 507, etc. The body 502, the openings 505, and the inserts 504 can be structured and arranged for simulating an ovariectomy procedure. For example, the openings 505 can be formed in a dorsal region of the body 502 and the inserts 504 can include bodily structures corresponding to a female reproductive system (e.g., ovaries) of the simulated animal.

FIG. 15 shows a sixth embodiment of the surgical training device 600. Except where expressly indicated to the contrary or where clearly mutually exclusive, the surgical training device 600 can include each of the structures, features, and relationships previously described with respect to the surgical training devices 100, 200, 300, 400, 500 and vice versa. This can include for example the body 602 with the opening 605, the insert 604, covers, bodily structures, etc. The body 602, the opening 605, and the insert 604 can be structured and arranged for simulating a vasectomy procedure. For example, the opening 605 can be formed in a groin region of the body 602 and the inserts 604 can include bodily structures corresponding to a male reproductive system (e.g., testicles) of the simulated animal.

FIG. 16 shows a seventh embodiment of the surgical training device 700. Except where expressly indicated to the contrary or where clearly mutually exclusive, the surgical training device 700 can include each of the structures, features, and relationships previously described with respect to the surgical training devices 100, 200, 300, 400, 500, 600 and vice versa. This can include for example the body 702 with the opening 705, the insert 704, covers, bodily structures, etc. The body 702, the opening 705, and the insert 704 can be structured and arranged for simulating an acute myocardial infarction procedure. For example, the opening 705 can be formed in a chest region of the body 702 and the inserts 704 can include bodily structures corresponding to aspects of a cardiovascular system (e.g., a heart) of the simulated animal.

FIG. 17 shows an eighth embodiment of the surgical training device 800. Except where expressly indicated to the contrary or where clearly mutually exclusive, the surgical training device 800 can include each of the structures, features, and relationships previously described with respect to the surgical training devices 100, 200, 300, 400, 500, 600, 700 and vice versa. This can include for example the body 802 with the opening 805, the insert 804, covers, bodily structures, etc. The body 802, the opening 805, and the insert 804 can be structured and arranged for simulating a thymectomy procedure. For example, the opening 805 can be formed in a throat region of the body 802 and the inserts 804 can include bodily structures corresponding to a thymus of the simulated animal.

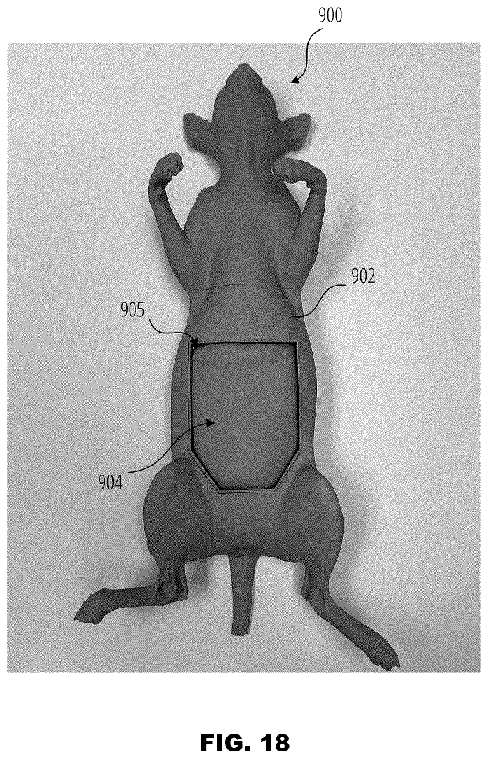

FIG. 18 shows a ninth embodiment of the surgical training device 900, which corresponds to a cat. Except where expressly indicated to the contrary or where clearly mutually exclusive, the surgical training device 900 can include each of the structures, features, and relationships previously described with respect to the surgical training devices 100, 200, 300, 400, 500, 600, 700, 800 and vice versa. This can include for example the body 902 with the opening 905, the insert 904, covers, bodily structures, etc.

Aspects of this invention are directed to a training method. The training method is described with reference to the surgical training device 100 but can additionally or alternatively be employed with any of the surgical training devices 200, 300, 400, 500, 600, 700, 800, 900. The training method can include covering the first frame 108 with the first layer 112 and forming the insert 104 by nesting the first frame 108 within the second frame 110 (FIG. 6) to hold the first layer 112 in a friction fit between the first frame 108 and the second frame 110 to tension the first layer 112 across an opening of the first frame 108. In embodiments, the training method can include covering, after nesting the first frame 108 within the second frame 110, the second frame 110 with the second layer 116 and nesting the second frame 110 within the third frame 114 (FIG. 8) to hold the second layer 116 in a friction fit between the second frame 110 and the third frame 114 to tension the second layer 116 across an opening of the second frame 110.

The training method can include inserting the insert 104 into the opening 105 of the body 102 (FIGS. 9-11) and performing a surgical training procedure on the first layer 112 and/or the second layer 116 (FIG. 12). In embodiments, before inserting the insert 104 into the opening 105 the first layer 112 and/or the second layer 116 can be trimmed. The first layer 112 and/or the second layer 116 can be trimmed to completely cover the opening of the respective first frame 108 or second frame 110 with sufficient overhang to form the previously described friction fit.

It will be appreciated that the foregoing description provides examples of the invention. However, it is contemplated that other implementations of the invention may differ in detail from the foregoing examples. All references to the invention or examples thereof are intended to reference the particular example being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

What is claimed is:

1. A surgical training device comprising:
a body shaped to correspond to an animal; and
an insert configured to be removably inserted into an opening in the body, wherein:
the insert is configured to be covered by a cover configured to be removably attached to the insert, and
an entirety or majority of the body, the insert, and the cover comprises materials sourced from sources other than the animal.

2. The surgical training device of claim 1, wherein no portion of the body, the cover, and the insert comprises materials sourced from the animal.

3. The surgical training device of claim 1, further comprising a bodily structure within the insert, and
an entirety or majority of the bodily structure comprises materials sourced from sources other than the animal.

4. The surgical training device of claim 3, wherein:
the bodily structure is an anatomically accurate reproduction of an organ of the animal, and
no portion of the bodily structure comprises materials sourced from the animal.

5. The surgical training device of claim 3, wherein the bodily structure comprises an anatomically accurate reproduction of one or more of a liver, a pancreas, skin, an ovary, a heart, a testicle, a thymus, muscles, a trachea, or a bone of the animal.

6. The surgical training device of claim 1, wherein the animal is a mammal.

7. The surgical training device of claim 1, wherein the animal is a rodent.

8. The surgical training device of claim 1, wherein the animal comprises one of a rat, a mouse, a guinea pig, a hamster, a rabbit, a cat, a dog, a bobcat, a javelina, a possum, a raccoon.

9. The surgical training device of claim 1, wherein the opening is defined in a belly of the body.

10. The surgical training device of claim 1, wherein the opening is defined in a back of the body.

11. The surgical training device of claim 1, wherein the insert is a first insert and the surgical training device further comprises a second insert.

12. The surgical training device of claim 11, wherein the first insert and the second insert are configured to be interchangeably inserted into the opening in the body.

13. The surgical training device of claim 11, wherein:
the opening in the body is a first opening and the body further comprises a second opening, and
the second insert is configured to be removably inserted into the second opening in the body.

14. The surgical training device of claim 1, wherein the cover comprises a first layer and a second layer.

15. The surgical training device of claim 14, wherein the first layer is an inner layer configured to correspond to internal tissue of the animal and the second layer is an outer layer configured to correspond to skin of the animal.

16. The surgical training device of claim 15, wherein:
the insert comprises an inner frame, an outer frame, and intermediate frame,
the inner frame is configured to nest within the intermediate frame and to hold the inner layer in a friction fit between the inner frame and the intermediate frame to tension the inner layer across an opening of the inner frame, and
the intermediate frame is configured to nest within the outer frame and to hold the outer layer in a friction fit between the intermediate frame and the outer frame to tension the outer layer across an opening of the intermediate frame.

17. A training method using a surgical training device, the training method comprising:
covering a first frame with a first layer;
forming an insert of the surgical training device by nesting the first frame within a second frame to hold the first layer in a friction fit between the first frame and the second frame to tension the first layer across an opening of the first frame;
inserting the insert into an opening of a body of the surgical training device, wherein the body is shaped to correspond to an animal, wherein an entirety or majority of the body and the insert comprise materials sourced from sources other than the animal; and
performing a surgical training procedure on the first layer.

18. The training method of claim 17, further comprising trimming, before inserting the insert into the opening, the first layer.

19. The training method of claim 17, wherein forming the insert comprises:
covering, after nesting the first frame within the second frame, the second frame with a second layer; and
nesting the second frame within a third frame to hold the second layer in a friction fit between the second frame and the third frame to tension the second layer across an opening of the second frame.

20. The training method of claim 19, further comprising trimming, before inserting the insert into the opening, the first layer and the second layer.
